(19) United States
(12) Patent Application Publication
(10) Pub. No.: US 2009/0288356 A1
(43) Pub. Date: Nov. 26, 2009

(54) ANCHORING FRAMING TO SUPPORT STRUCTURES

(76) Inventors: William Fitzpatrick, Nipomo, CA (US); Craig Scott, Huntington Beach, CA (US)

Correspondence Address: ITALIA IP, 3500 WEST OLIVE AVE., SUITE 300, BURBANK, CA, 91505, US

(21) Appl. No.: 12/123,843

(22) Filed: May 20, 2008

(51) Int. Cl. E02D 27/00; F16B 21/00; F16B 43/00

(52) U.S. Cl. 52/295; 411/339; 411/531

(57) ABSTRACT

Fixing a framing plate to a support structure, using one or more anchor bolts embedded within the support structure. A first hole drilled into the plate is to an oversize diameter which accepts a threaded sleeve. The threaded sleeve extends an effective length of the anchor bolt and may comprise a drive head and an interference member, which engages the plate directly or through a washer to fix the plate to the support structure.

### FIELD OF THE INVENTION

The present invention relates to method and apparatus for anchoring framing elements of building structures to support structures such as a concrete foundation.

### BACKGROUND OF THE INVENTION

Many buildings structures, such as houses, are built using framing, such as wood framing, secured to a foundation, such as a poured concrete foundation. Subsequent building may include building a wooden frame on the foundation. Attachment of wooden framing is typically accomplished by fixing horizontal framing members, usually called plates or ledgers, to the upper exposed surfaces of the foundation.

Attachment of plates may rely upon anchor bolts, which are embedded within the concrete when the latter is poured. Anchor bolts leave a certain extent of threaded shaft projecting upwardly from the exposed upper surface of the foundation. Plates are fixed to the concrete by passing the exposed portion of each anchor bolt through holes formed in the plates.

Ideally, the exposed portion of each anchor bolt is long enough to extend beyond the plate sufficiently for a fastener such as a nut to be threaded onto the shaft of the anchor bolt, with a washer or the like to assure that the plate be pinned to the foundation when the nut is tightened.

However, in many cases, anchor bolts do not extend sufficiently to permit nuts to be threaded thereonto after the plate is in place. An example is shown in FIG. 9, which shows three of a number of possible situations. At the left in FIG. 9, an anchor bolt 2A is sufficiently exposed outside the plate 10 so that a traditional nut 6 and washer 14 can be threaded onto the anchor bolt 2A. This represents the ideal condition which is not always the case. Anchor bolts 2B and 2C illustrate cases in which the respective anchor bolts 2B and 2C are insufficiently exposed to accept a traditional nut 6 and washer 14. However, both anchor bolts 2B and 2C extend outside the concrete member 4 to accept a threaded fastener such as the nut 6 if the plate 10 were not present.

One known method of coping with this problem has been to enlarge the hole originally drilled into the plate 10 using a hole saw. This method entails an additional step in that first, the hole is drilled, typically using a drill bit, and subsequently, the hole is widened to a diameter permitting the washer 14 and the nut 6 to enter the newly enlarged hole. This method entails unnecessary duplicated labor. Also, in cases wherein the anchor bolt has a very limited exposed length, the portion of the plate 10 which will be under the washer is consequently limited in thickness and therefore subject to breaking or deteriorating over time under excessive compressive forces imposed by tightening the nut. In this latter occurrence, it is conceivable that no clamping or retaining function would be provided at the location of the anchor bolt 2.

The construction industry has a need for improved ways of coping with inadequately exposed anchor bolts.

### SUMMARY OF THE INVENTION

The present invention answers the above need by providing method and apparatus which facilitates and expedites fixing of plates to supporting concrete strata bearing anchor bolts.

In particular, this application discloses a method of constructing wood framing which will subsequently comprise at least one plate installed on a support structure bearing at least one outwardly exposed embedded anchor bolt, comprising the steps of: for at least one anchor bolt location, drilling entirely through the plate a hole with a diameter great enough to accept both the diameter of an anchor bolt and the diameter of a sleeve member of a threaded sleeve fastener, wherein said sleeve member is dimensioned and configured to threadably engage and advance along the anchor bolt, and wherein said plate has a proximal surface abutting the support structure and an opposed distal surface, thickness defined between the proximal surface and the opposed distal surface; placing the plate onto the support structure, such that each one of the anchor bolts is accepted by the holes drilled into the plate; and, fixing the plate to the support structure using the threaded sleeve fastener, wherein the threaded sleeve fastener comprises: a sleeve member threadably engaged to at least one of said anchor bolts, wherein the threaded sleeve member has an axial opening and internal threads which are matingly compatible with the threads of one of the anchor bolts, and wherein the sleeve member has a minimum length, and a drive head, wherein the drive head includes means for driving the threaded sleeve fastener onto the anchor bolt, and an interference member.

This application also discloses a building construction comprising: a support structure having an exposed surface and at least one anchor bolt embedded within the support structure, wherein the anchor bolt has a threaded shaft projecting outwardly from the exposed surface; a plate fixed to the support structure, wherein the plate has a proximal surface abutting the support structure and an opposed distal surface, thickness defined between the proximal surface and the opposed distal surface, and a relief hole for each anchor bolt; and at least one threaded sleeve fastener threadably engaged to said anchor bolt, thereby fixing said plate to said support structure, wherein said threaded sleeve fastener includes: a sleeve member threadably engaged to at least one of said anchor bolts, wherein the threaded sleeve member has an axial opening and internal threads which are matingly compatible with the threads of one of the anchor bolts, and wherein the sleeve member has a minimum length, and a drive head, wherein the drive head includes means for driving the threaded sleeve fastener onto the anchor bolt, and an interference member.

This application also discloses a building construction comprising: a support structure having an exposed surface and at least one anchor bolt embedded within the support structure, wherein the anchor bolt has a threaded shaft projecting outwardly from the exposed surface; a plate fixed to the support structure, wherein the plate has a proximal surface abutting the support structure and an opposed distal surface, thickness defined between the proximal surface and the opposed distal surface, and a hole formed therein for each anchor bolt, wherein the hole has a diameter great enough to accept both the diameter of the anchor bolt and the diameter of a sleeve member of a threaded sleeve fastener; and at least one threaded sleeve fastener threadably engaged to said anchor bolt, thereby fixing said plate to said support structure, wherein said threaded sleeve fastener includes: a sleeve member threadably engaged to at least one of said anchor bolts, wherein the threaded sleeve member has an axial opening and internal threads which are matingly compatible with the threads of one of the anchor bolts, and a drive head, wherein the drive head includes means for driving the threaded sleeve fastener onto the anchor bolt and an interference member, and wherein the drive head remains outside the plate when the threaded sleeve fastener is threadably engaged onto its associated anchor bolt.

This application further discloses a threaded sleeve fastener device for anchoring a plate to support structures utilizing anchor bolts, said device comprising: a sleeve member, wherein the sleeve member has an axial opening and internal threads which are matingly compatible with the threads of said anchor bolt; a drive head, wherein the drive head includes means for driving the threaded sleeve fastener onto the anchor bolt; and an interference member.

Sites of anchor bolts which are originally of sufficient exposed length to accept a nut and washer assembly may be completed in the traditional fashion, wherein for example clamping nuts and washers may be installed on the sufficiently long anchor bolts, or using the methods and devices disclosed herein.

The sleeve member of the threaded sleeve fastener may have a minimum length so as to minimize a gap or void which would otherwise exist below the threaded sleeve and above the support structure. The minimum length may be substantially equal to the thickness of the plate or substantially equal to the length of the plate and the thickness of the washer or washers used.

According to another aspect of the invention, the internally threaded sleeve and any fastener formed as part thereof may have a viewing window to enable an inspector to confirm that an anchor bolt has been engaged sufficiently by the sleeve.

It is an object of the invention to expedite attachment of framing plates to supporting strata bearing anchor bolts which may be too short to enable ready engagement of threads.

It is another object of the invention to eliminate gaps and compression of plates by members which serve to extend effective length of anchor bolts which are too short to enable ready engagement of threads using traditional methods or provide the alternative attachment method and devices disclosed herein.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an exploded side cross sectional view of a construction according to at least one aspect of the invention.

FIG. 2 is a side cross sectional view showing the components of FIG. 1 as they would be after final assembly.

FIG. 3 is a side view of a construction according to still another aspect of the invention, shown partly in cross section.

FIG. 4 is a side view of a construction according to still a further aspect of the invention, shown partly in cross section.

FIG. 5 is a side view of a construction according to yet another aspect of the invention, shown prior to installation of a fastener, and is shown partly in cross section.

FIG. 6 is a side view of FIG. 5, shown after installation of the fastener.

FIG. 7 is a side view of a construction according to a further aspect of the invention, shown partly in cross section.

FIG. 8 is a block diagram of steps of a method according to at least one aspect of the invention, and is read starting from the upper left.

FIG. 9 is a side view of a construction according to traditional practice and illustrates the problem being solved by the present invention, and is shown partly in cross section.

### DETAILED DESCRIPTION

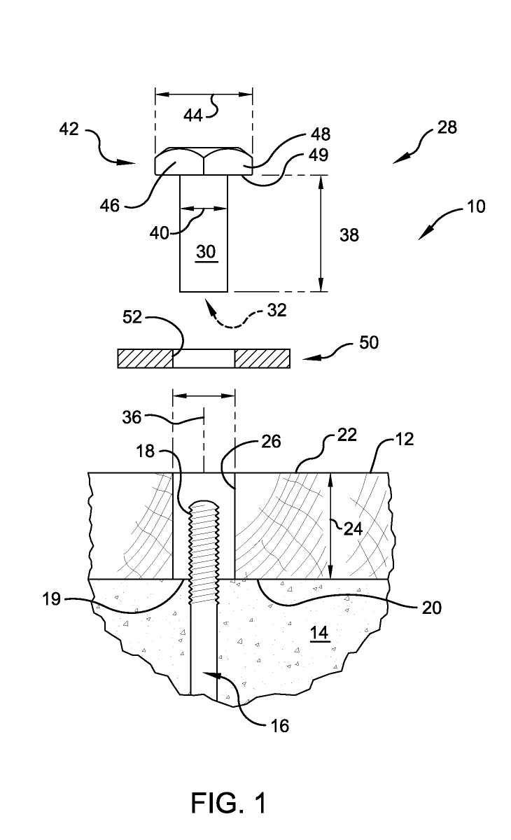

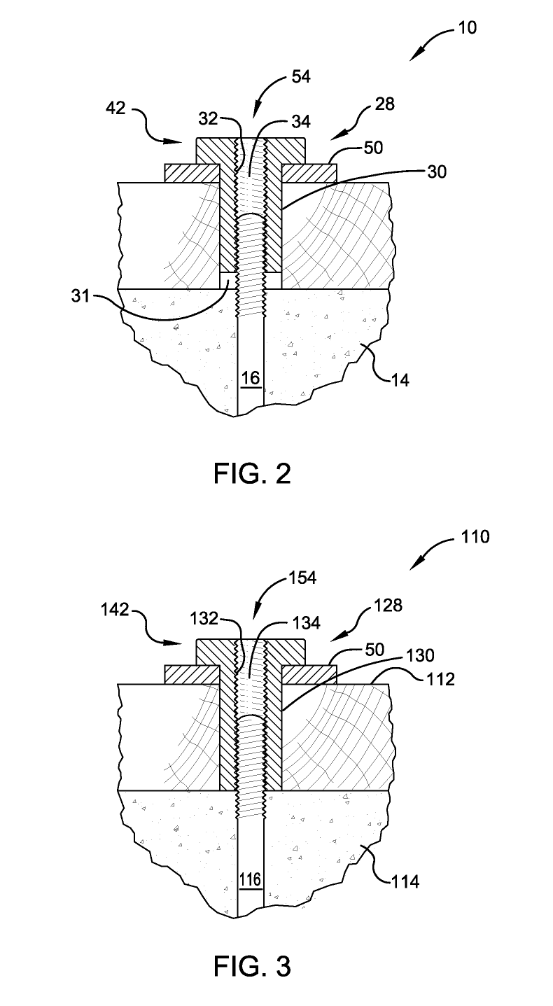

FIGS. 1 and 2 show an exemplary construction 10 according to at least one aspect of the invention. The exploded view of FIG. 1 shows a framing plate 12 which has been placed onto the upper surface of a support structure, in this example, a concrete structure 14 which serves to provide a supporting stratum for the plate 12. The concrete structure 14 may be any other type of support structure, which presents an exposed surface to which further building structure will subsequently be attached, as such, as used herein, a “support structure” includes, but is not limited to: upwardly exposed foundation walls, concrete masonry unit or block walls, vertical columns, wood or steel beams (tube or I-beams), and slabs.

An anchor bolt 16 is embedded within the concrete structure 14. The anchor bolt performs the conventional function of providing a convenient and effective way of fastening framing members generally, and more particularly, horizontally oriented plates such as the plate 12. The anchor bolt 16 comprises a threaded shaft bearing threads 18 which projects outwardly from the exposed surface 19 of the concrete structure 14.

After being placed onto the concrete structure 14, the plate 12 must be securely fixed thereto to preclude movement. The plate 12 has a proximal surface 20 which abuts the concrete structure 14, an opposed distal surface 22, and thickness (represented as arrow 24) defined between the proximal surface 20 and the distal surface 22. A relief hole 26 enables the anchor bolt 16 to avoid interference with the plate 12 when the plate 12 is placed onto the concrete structure 14. Other relief holes (not shown) are provided to accommodate other anchor bolts (not shown).

A clamp arrangement is provided to impose compressive or clamping forces onto the plate 12 using the anchor bolt 16. A fastener 28 is arranged to pin or fix the plate 12 to the concrete structure 14 by engaging any of the anchor bolts, such as the anchor bolt 16. The fastener 28 may comprise a sleeve member 30. Referring also to FIG. 2, the sleeve member 30 may have an axial opening 32 and internal threads 34 which are matingly compatible with the threads of the anchor bolts, thereby being dimensioned and configured to threadingly engage and advance along the anchor bolt 16. The sleeve member may have minimum length (represented as arrow 38) along the axis of rotation 36 of threading. This minimum length 38 may be substantially equal the thickness 24 of the plate 12 or substantially equal to the length of the plate 12 and the thickness of the washer 50 or washers used. The sleeve member 30 has a diameter (represented as arrow 40) which is perpendicular to the length 38.

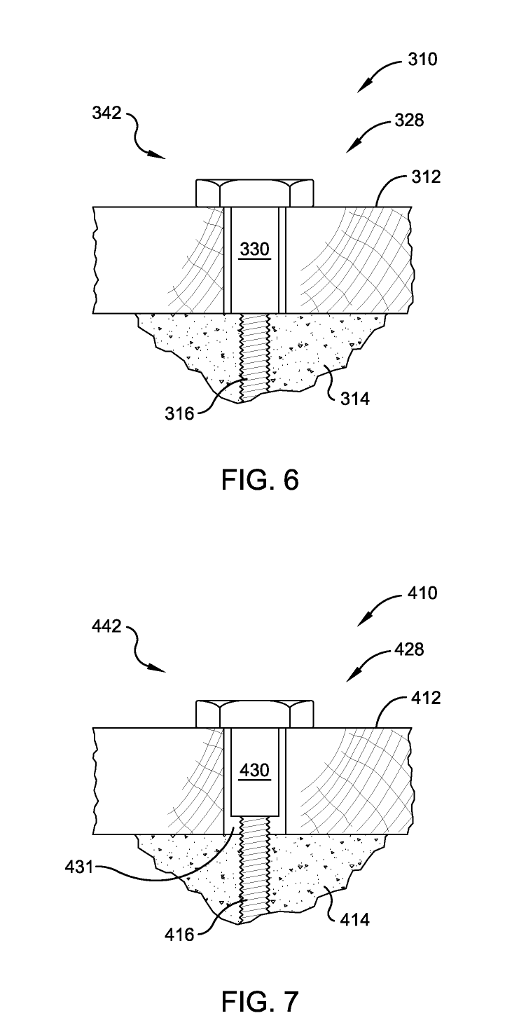

The fastener 28 may comprise a drive head 42 having a diameter (represented as arrow 44) which is greater than the diameter 40 of the sleeve member 30. The drive head 42 may be formed integrally with the sleeve member 30 to define an internally threaded bolt. The drive head 42 may have driving means such as at least one wrench surface (two wrench surfaces 46 and 48 are depicted as representative of a hexagonal circumference of configuration typical of bolts in general use). The wrench surface or surfaces, such as the wrench surfaces 46 and 48, enable the drive head 42 and hence the sleeve member 30, where the sleeve member 30 is integral with the drive head 42, to be threaded onto the anchor bolt 16 by a tool (not shown) having wrench structure which can drivingly engage the wrench surface or surfaces. The drive head 42 may also include an interference member 49 that consist of a portion of the drive head 42 that is of a greater diameter than the sleeve member 30. In one embodiment, the interference member 349 may be substantially broad to engage the plate 312 as shown in FIGS. 5 and 6. In another embodiment, the interference member 49 is sufficiently broad to engage a washer 50 disposed between the drive head 42 and the plate 12, as shown in FIGS. 1 and 2.

As described briefly above, the fastener 28 may comprise a separate washer, such as a flat washer 50 having a central hole 52 which is sufficiently large to pass the sleeve member 30 therethrough and which is dimensioned and configured to increase lateral span of the driver head 42. Lateral span of the drive head 42 refers to that dimension which is perpendicular to the axis of rotation 36, or the right-to-left dimension as depicted in FIGS. 1 and 2. Lateral span of the driver head 42 (the direction extending from left to right in FIG. 1) generates interfering abutment with the washer 50, whereby placing the washer 50 beneath the interference member 49 of the driver head 42 and above the plate 12 enables the washer 50 to pin or fix the plate 12 against the concrete structure 14 when the fastener 28 is threaded onto the anchor bolt 16.

Regardless of whether the drive head 42 has sufficient lateral span to contact the plate 12 directly and impose clamping forces thereon, or whether an intervening member such as the washer 50 must be interposed to increase the effective span of the drive head 42, it will be understood that the interference member 49 is disposed by one of either direct contact or by an intervening washer, to impose clamping forces against the plate when the threaded sleeve fastener 28 is tightened onto its associated anchor bolt.

A viewing window 54 may be formed in the drive head 42 which is open to reveal the anchor bolt 16 to view after assembly of the construction 10 is complete, as depicted in FIG. 2. The viewing window 54 may comprise an extension of the axial opening 32, and may be either threaded as shown in FIG. 2 or it may be unthreaded.

The sleeve member 30 of the fastener 28 has a length which is coincident with the axis of the anchor bolt 16. As shown in FIG. 2, this length may be such that a void or gap 31 exists between the bottom of the sleeve member 30, as seen in FIG. 2, and the concrete structure 14. While this gap 31 may be about equal to the thickness of the washer 50, it may also be greater or smaller. It is also possible that the length of the sleeve member 30, is such that it abuts the concrete structure 14. In any case, as defined herein, the minimum length of the sleeve member 30, 130, 230, 330 may be: a) substantially equal to the thickness of the plate 312, as seen in FIG. 6, wherein the thickness of a plate is about 1.5 inches to about 3.5 inches, and more particularly about 1.5 inches, about 2.5 inches, and about 3.5 inches; b) such that it leaves a gap 31 between the sleeve member 30 and the concrete structure 14 when the threaded sleeve fastener is secured to the anchor bolt with a washer 50 placed between the plate 12 and the interference member 49 of the threaded sleeve fastener 28 located above the plate, wherein the gap 31 is substantially equal to the thickness of the washer used, as seen in FIG. 2, wherein the thickness of the washer is about ¼ of an inch to about ⅜ of an inch; and c) such that the threaded sleeve member 30, 330 abuts the concrete structure 14, 314 when the threaded sleeve fastener 28, 328 is secured to the anchor bolt 16, 316 with or without a washer 50, as seen in FIGS. 3 and 6 respectively.

It will be noted in FIG. 2 that the drive head 42 of the threaded sleeve fastener 28 remains outside the distal or outer surface 22 of the plate 12 when the threaded sleeve fastener 28 is securely threaded to the anchor bolt 16.

Referring now to FIG. 3, another construction 110 is shown wherein a plate 112 is to be fixed to a concrete structure 114 using an anchor bolt 116 which is exposed below the upper surface of the plate 112. A threaded sleeve fastener 128 is used in the manner of the threaded sleeve fastener 28 of FIG. 1. The threaded sleeve fastener 128 has the structural and functional characteristics of the threaded sleeve fastener 28 of FIG. 1, such as a sleeve member 130, an axial opening 132 bearing internal threads 134, a drive head 142, and a viewing window 154. As shown herein, the minimum length of the sleeve member 130 is such that after the threaded sleeve fastener 128 is tightened, the bottom of the sleeve member 130 abuts the concrete structure 114. The same washer 50 as employed in FIG. 1 may be employed in the construction 110.

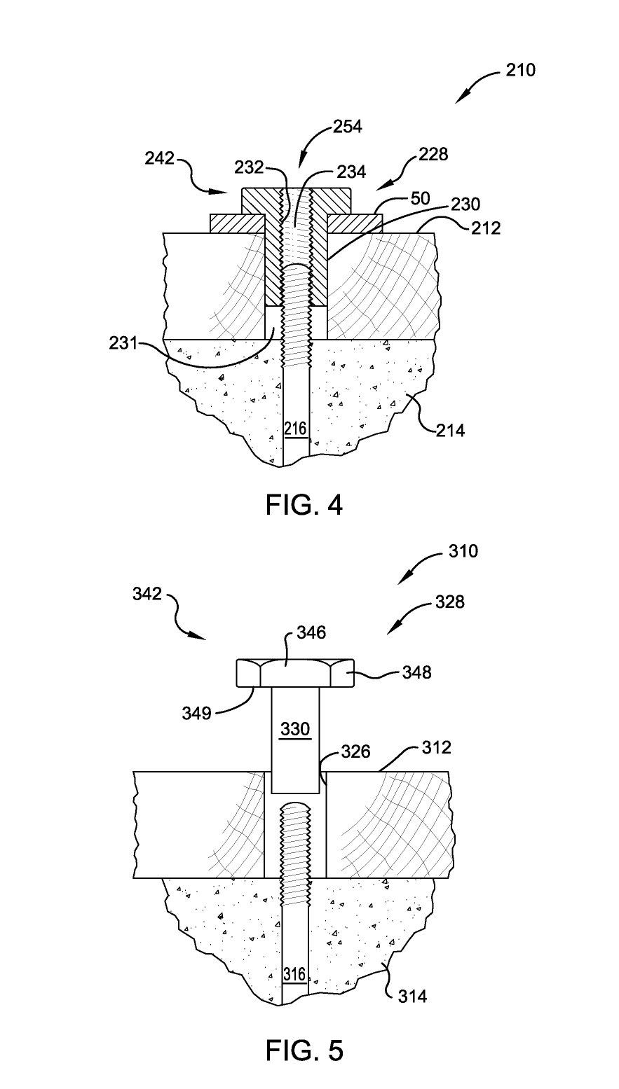

FIG. 4 shows a further variation of the construction 10 of FIG. 2 including a threaded sleeve fastener 228 having a drive head 242, a sleeve member 230, an axial opening 232 bearing internal threads 234, and a viewing window 254. In the construction 210 of FIG. 4, the length of the sleeve member 230 is so short that a gap 231 existing between the sleeve member 230 and the concrete structure 214 is greater in magnitude than the gap 31 of FIG. 2 such that the minimum length of a given sleeve member, as defined above, is not utilized.

FIG. 5 shows a construction 310 according to a further aspect of the invention, which is seen to comprise a concrete structure 314 in which an anchor bolt 316 is embedded. A fastener 328 enables compressive forces to be generated by tightening the fastener 328 onto the anchor bolt 316. Forces so generated are imposed by the drive head 342 directly onto the plate 312 through an interference member 349, which is substantially broad to engage the plate 312 without the use of a washer. The fastener 328 has a sleeve member 330 which may be structurally and functionally similar to the sleeve member 30 of FIG. 1, having an axial opening (not shown, but similar to the axial opening 32) and viewing window (not shown, but similar to the axial opening 54 of FIG. 2). A relief hole 326 accepts the sleeve member 330. The drive head 342 has wrench surfaces 346 and 348. It would be feasible to eliminate the wrench surfaces 346 and 348 by, for example, forming the viewing window to have wrench surfaces. Illustratively, the viewing window could be formed as square or hexagonal, in order to accept square and hexagonal drives of ordinary hand tools. Of course, any viewing window of any of the fasteners of the present invention may be so provided and configured. Any of the same fasteners may have both types of wrench surfaces if desired. The drive head 342 comprises a lower surface 349 which may be regarded as an interference member which contacts and imposes clamping forces directly onto the plate 312.

FIG. 6 shows the threaded sleeve fastener 328 fully tightened onto the anchor bolt 316. The minimum length of the sleeve member 330 is such that the sleeve member 330 abuts the concrete structure 314 when the threaded sleeve fastener 328 is fully tightened as shown.

FIG. 7 shows a construction 410 which is generally similar to the construction 310 of FIGS. 5 and 6, other than the length of the sleeve member 430 of the threaded sleeve fastener 428. As in the prior constructions, a plate such as the plate 412 is to be fixed to a concrete structure bearing an embedded anchor bolt, such as the concrete structure 414 and the anchor bolt 416. The threaded sleeve fastener 428 is structurally and functionally similar to the threaded sleeve fastener 328 of FIGS. 5 and 6, apart from the length of the sleeve member 430. The length of the sleeve member 430 is such that when the threaded sleeve fastener 428 is tightened onto the anchor bolt 416 as shown, a gap 431 will exist between the bottom of the sleeve member 430 and the concrete structure 414, such that the minimum length of a given sleeve member, as defined above, is not utilized.

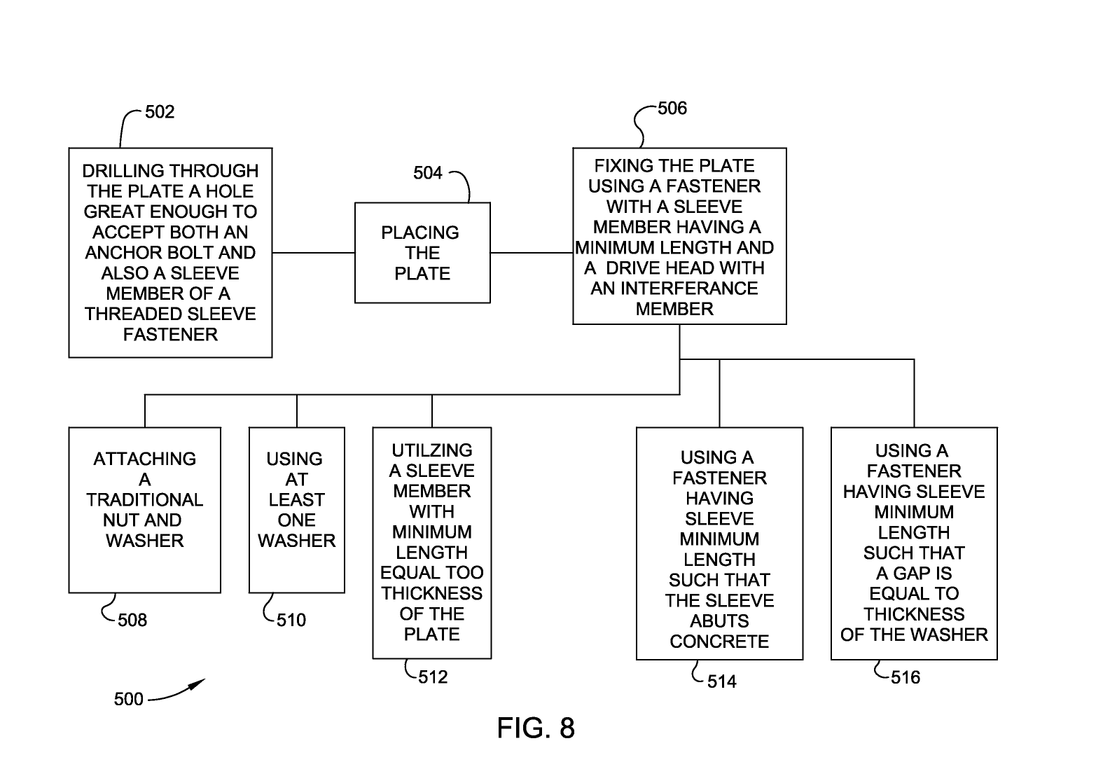

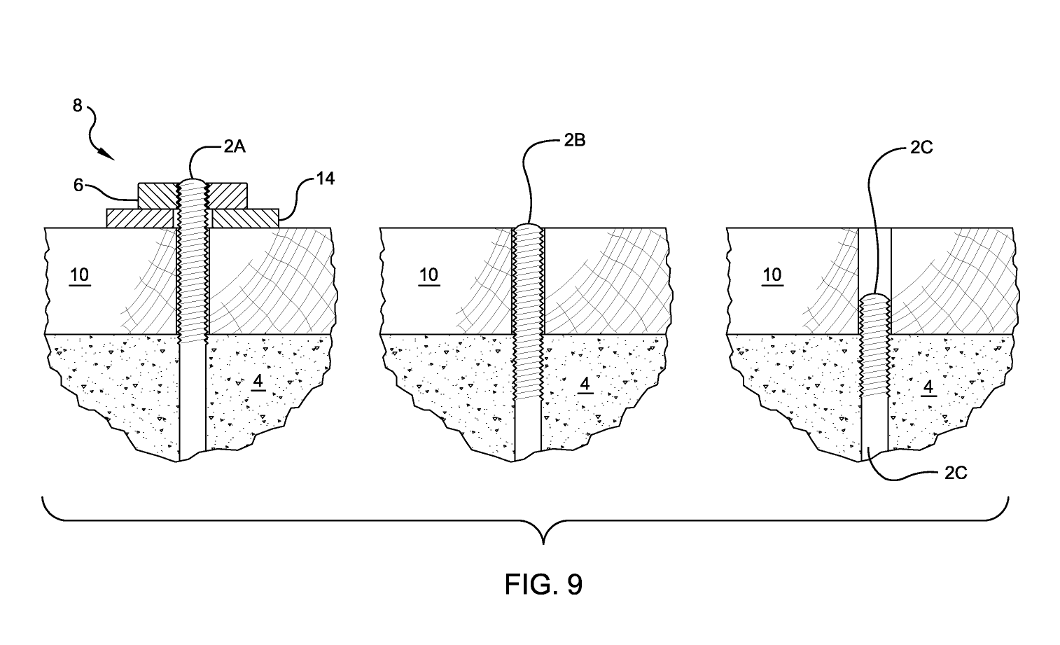

Turning now to FIG. 8, the invention may be regarded as a method 500 of constructing wood framing which will subsequently comprise at least one plate installed on a concrete structure bearing at least one and in most cases, a plurality of outwardly exposed embedded anchor bolts. The construction elements referred to prior may be of constructions 10, 110, and 310, for example. The steps of the method 500 are shown in abbreviated or summary form in FIG. 8 and are set forth more fully hereinafter.

The method 500 may comprise a step 502 of for at least one anchor bolt location, drilling or boring into and entirely through the plate, such as the plate 12, in a first and sole drilling or boring operation a hole such as the relief hole 26 of diameter great enough to accept both one of the anchor bolts, such as the anchor bolt 16, and also at least a portion of the internally threaded sleeve member of a threaded sleeve fastener, such as the threaded sleeve member 30 of the threaded sleeve fastener 28, wherein the sleeve member is dimensioned and configured to threadably engage and advance along the anchor bolt, and wherein the plate has a proximal surface abutting the concrete structure and an opposed distal surface, with thickness defined between the proximal surface and the opposed distal surface.

The method 500 may comprise a further step 504 of placing the plate, such as the plate 12, onto the concrete structure, such as the concrete structure 14, subsequently to the step of drilling or boring into and entirely through the plate a hole, such as the relief hole 26, such that each one of the anchor bolts is accepted by the holes drilled into the plate.

The method 500 may comprise a still further step 506 of fixing the plate, such as the plate 12, to the concrete structure, such as the concrete structure 14, using the threaded sleeve fastener, such as the threaded sleeve fastener 28, where the sleeve member associated with the threaded sleeve fastener has a minimum length as defined herein. As part of this step 506, each sleeve member used is threadably engaged to one of the anchor bolts, the threaded sleeve member having an axial opening and internal threads which are matingly compatible with the threads of one of the anchor bolts, and wherein the sleeve member further has a drive head including means for driving the threaded sleeve fastener onto the anchor bolt, and an interference member for imposing clamping forces to the plate either directly as shown in FIG. 6 or through the use of a washer as shown in FIG. 2. In this case of using a washer 50, the step 506 is modified to comprise a further step 510 of using at least one washer, and wherein the interference member 49 of the fastener, and more particularly the drive head 42, is sufficiently broad enough to engage the washer 50.

Clamping forces may also be imposed on the plate, such as the plate 12, in additional way. For example, the method 500 may further comprise a step 508 of attaching a traditional nut and washer, such as the nut 6 and the washer 14. The step 508 is practiced where sufficient length of an anchor bolt is exposed to engage the nut, such as is seen with the anchor bolt 2A in FIG. 9.

The step 506 of fixing the plate to the concrete structure using the threaded sleeve fastener may comprise the further step 512 of utilizing a fastener wherein the sleeve member minimum length is substantially equal to the thickness of the plate, such as the sleeve member 330 of FIG. 6.

The step 506 of fixing the plate to the concrete structure using the threaded sleeve fastener may comprise the further step 514 of utilizing a fastener wherein the sleeve member minimum length is such that sleeve member substantially abuts the concrete structure when the threaded sleeve fastener is secured to the anchor bolt, such as the sleeve member 130 of FIG. 3.

The step 506 of fixing the plate to the concrete structure using the threaded sleeve fastener may comprise the further step 516 of utilizing a fastener having a sleeve member, such as the threaded sleeve fastener 28 of FIG. 2, wherein the sleeve member minimum length is such that a gap between the sleeve member and the concrete is substantially equal to the thickness of the washer when the fastener is engaged to the anchor bolt, as seen in the construction 10 of FIGS. 1 and 2.

It will be understood, of course, that a washer such as the washer 50 may be provided for shimming purposes rather than to transmit compressive forces.

It should be noted that the minimum length of a sleeve member, as defined herein, need not approach this equality in dimensions. It is merely necessary that the length of the sleeve member not exceed the thickness dimension of the plate, so that interference with the associated concrete structure, such as the concrete structure 14 of FIG. 1, will not prevent effective clamping action. It is further noted that some embodiments of this disclosure do not require a minimum length as defined herein, namely as shown and described in FIGS. 4 and 7. In this case, any shorter dimension is possible, provided that there is sufficient length to enable assembly and clamping action as described herein. And a longer dimension is possible where a washer, such as the washer 50 of FIG. 1, is provided as a shim.

The threaded sleeve member, such as the threaded sleeve member 30 and 330 of FIGS. 1 and 5, can be further defined as having a minimum length that it is capable of securely threadably engaging an anchor bolt, such as the anchor bolt 16, wherein the anchor bolt has a minimum length extending outwardly from the concrete structure such that a traditional nut or traditional nut and washer assembly can be securely threaded thereto in the absence of a plate.

The present invention contemplates applications in any variety of support structures, including but not limited to, upwardly exposed foundation walls, concrete masonry unit or block walls, vertical columns, wood or steel beams (tube or I-beams). In addition, horizontal orientation of anchor bolts in such support structures is contemplated. Downwardly facing surfaces, such as soffit surfaces, are encompassed within the invention. Inclined or diagonally arranged surfaces, such as for example for ramps and support structures for stairways may enjoy the benefits of the invention.

The inventive constructions may be applied to structures other than general framing such as that for walls and partitions. For example, support members for signs, ceiling fans, chandeliers, audiovisual equipment, heating, ventilating, and air conditioning equipment, electrical transformers, lighting equipment, and other items which depend from a building may be fixed to anchor bolts using any principle of any aspect of the invention.

The invention is not to be limited by the examples presented above, but is to encompass any structures falling within the scope of the appended claims.

We claim:

1. A method of constructing wood framing which will subsequently comprise at least one plate installed on a support structure bearing at least one outwardly exposed embedded anchor bolt, comprising the steps of:
for at least one anchor bolt location, drilling entirely through the plate a hole with a diameter great enough to accept both the diameter of an anchor bolt and the diameter of a sleeve member of a threaded sleeve fastener, wherein said sleeve member is dimensioned and configured to threadably engage and advance along the anchor bolt, and wherein said plate has a proximal surface abutting the concrete structure and an opposed distal surface, thickness defined between the proximal surface and the opposed distal surface;
placing the plate onto the support structure, such that each one of the anchor bolts is accepted by the holes drilled into the plate; and,
fixing the plate to the support structure using the threaded sleeve fastener, wherein the threaded sleeve fastener comprises
a sleeve member threadably engaged to at least one of said anchor bolts, wherein the sleeve member has an axial opening and internal threads which are matingly compatible with the threads of one of the anchor bolts, and wherein the sleeve member has a minimum length, and
a drive head, wherein the drive head includes means for driving the threaded sleeve fastener onto the anchor bolt, and an interference member.

2. The method according to claim 1, wherein the step of fixing the plate to the support structure further comprises attaching a traditional nut and washer assembly to at least one of the anchor bolts having a sufficient exposed height above said plate.

3. The method according to claim 1, wherein the step of fixing the plate to the support structure using the threaded sleeve fastener utilizes a fastener wherein the sleeve member minimum length is about equal to the thickness of the plate.

4. The method according to claim 1, wherein the step of fixing the plate to the support structure using the threaded sleeve fastener utilizes a fastener wherein the interference member is integral with the drive head and substantially broad to engage said plate.

5. The method according to claim 1, wherein the step of fixing the plate to the support structure using the threaded sleeve fastener utilizes a fastener wherein the sleeve member minimum length is such that sleeve member substantially abuts the support structure when the threaded sleeve fastener is secured to the anchor bolt.

6. The method according to claim 1, wherein the step of fixing the plate to the support structure using the threaded sleeve fastener further comprises using a at least one washer, and wherein said interference member of said fastener is sufficiently broad to engage said washer.

7. The method according to claim 6, wherein the step of fixing the plate to the support structure using the threaded sleeve fastener utilizes a fastener, wherein the sleeve member minimum length is such that a gap between the sleeve member and the support is substantially equal to the thickness of the washer when said fastener is engaged to said anchor bolt.

8. A building construction comprising:
a support structure having an exposed surface and at least one anchor bolt embedded within the support structure, wherein the anchor bolt has a threaded shaft projecting outwardly from the exposed surface;
a plate fixed to the support structure, wherein the plate has a proximal surface abutting the support structure and an opposed distal surface, thickness defined between the proximal surface and the opposed distal surface, and a relief hole for each anchor bolt; and
at least one threaded sleeve fastener threadably engaged to said anchor bolt, thereby fixing said plate to said support structure, wherein said threaded sleeve fastener includes
a sleeve member threadably engaged to at least one of said anchor bolts, wherein the sleeve member has an axial opening and internal threads which are matingly compatible with the threads of one of the anchor bolts, and wherein the sleeve member has a minimum length, and
a drive head, wherein the drive head includes means for driving the threaded sleeve fastener onto the anchor bolt, and an interference member.

9. The building construction according to claim 8, wherein the drive head of the threaded sleeve fastener remains outside the outer surface of the plate when the threaded sleeve fastener is securely threaded to the anchor bolt.

10. The building construction according to claim 8, further comprising a traditional nut and washer assembly threadably engaged to at least one of the anchor bolts having a sufficient exposed height above said plate.

11. The building construction according to claim 8, wherein the sleeve member minimum length is about equal to the thickness of the plate.

12. The building construction according to claim 8, wherein the interference member is integral with the drive head and substantially broad to engage said plate.

13. The building construction according to claim 8, wherein the hole in said plate has a diameter great enough to accept both one of the anchor bolts and also at least a portion of the sleeve member said threaded sleeve fastener

14. The building construction according to claim 8, wherein the sleeve member minimum length is such that sleeve member substantially abuts the support structure when the threaded sleeve fastener is secured to the anchor bolt.

15. The building construction according to claim 8, further comprising at least one washer disposed between said interference member and said plate.

16. The building construction according to claim 15, wherein the sleeve member minimum length is such that a gap between the sleeve member and the support is substantially equal to the thickness of the washer when said fastener is engaged to said anchor bolt.

17. A building construction comprising:
a support structure having an exposed surface and at least one anchor bolt embedded within the support structure, wherein the anchor bolt has a threaded shaft projecting outwardly from the exposed surface;
a plate fixed to the support structure, wherein the plate has a proximal surface abutting the support structure and an opposed distal surface, thickness defined between the proximal surface and the opposed distal surface, and a hole formed therein for each anchor bolt, wherein the hole has a diameter great enough to accept both the diameter of the anchor bolt and the diameter of a sleeve member of a threaded sleeve fastener; and
at least one threaded sleeve fastener threadably engaged to said anchor bolt, thereby fixing said plate to said support structure, wherein said threaded sleeve fastener includes
a sleeve member threadably engaged to at least one of said anchor bolts, wherein the sleeve member has an axial opening and internal threads which are matingly compatible with the threads of one of the anchor bolts, and
a drive head, wherein the drive head includes means for driving the threaded sleeve fastener onto the anchor bolt and an interference member, and wherein the drive head remains outside the plate when the threaded sleeve fastener is threadably engaged onto its associated anchor bolt.

18. The building construction according to claim 17, further comprising a traditional nut and washer assembly threadably engaged to at least one of the anchor bolts having a sufficient exposed height above said plate.

19. The building construction according to claim 17, wherein the interference member is integral with the drive head and substantially broad to engage said plate.

20. The building construction according to claim 17, further comprising at least one washer disposed between said interference member and said plate.

21. The building construction according to claim 17, wherein the sleeve member of said fastener has a minimum length.

22. The building construction according to claim 21, wherein the sleeve member minimum length is about equal to the thickness of the plate.

23. The building construction according to claim 21, wherein the sleeve member minimum length is such that sleeve member substantially abuts the support structure when the threaded sleeve fastener is secured to the anchor bolt.

24. The building construction according to claim 21, further comprising at least one washer disposed between said interference member and said plate, and wherein the sleeve member minimum length is such that a gap between the sleeve member and the support is substantially equal to the thickness of the washer when said fastener is engaged to said anchor bolt.

25. A threaded sleeve fastener device for anchoring a plate to support structures utilizing anchor bolts, said device comprising:
a sleeve member, wherein the sleeve member has an axial opening and internal threads which are matingly compatible with the threads of said anchor bolt, and wherein the sleeve member has a minimum length;
a drive head, wherein the drive head includes means for driving the threaded sleeve fastener onto the anchor bolt; and
an interference member.

26. The device of claim 25, wherein said interference member is integral with said drive head and substantially broad to engage said plate.

27. The device of claim 25, wherein the drive head remains outside the plate when the threaded sleeve fastener is threadably engaged onto an anchor bolt.

28. The device of claim 25, wherein the minimum length of said sleeve member of said fastener is about 1.5 inches to 3.5 inches.

29. The device of claim 25, further comprising at least one washer to be disposed between said interference member and said plate when the threaded sleeve fastener is threadably engaged onto an anchor bolt.

30. The device of claim 29, wherein said interference member is integral with said drive head and sufficiently broad to engage said washer.
